(19) United States
(12) Patent Application Publication
(10) Pub. No.: US 2026/0285058 A1
(43) Pub. Date: Sep. 24, 2026

(54) THERMAL PRINTER SYSTEM

(71) Applicant: Avery Dennison Retail Information Services LLC, Mentor, OH (US)

(72) Inventors: Rabah SHAATH, Sayre, PA (US); Subodh BANSODE, Sayre, PA (US)

(21) Appl. No.: 19/477,511

(22) PCT Filed: May 31, 2024
(86) PCT No.: PCT/IB2024/055364

§ 371 Date: Oct. 22, 2025

Related U.S. Application Data
(60) Provisional application No. 63/505,833, filed on Jun. 2, 2023.

(51) Int. Cl. B41J 2/365; B41J 2/325; B41J 2/375

(52) U.S. Cl. CPC B41J 2/365; B41J 2/375; B41J 2/325

(57) ABSTRACT

In some embodiments, a thermal printer system includes a print control device configured to be operatively connected to a thermal printhead having a thermal element. The print control device may be configured to output a plurality of quantized activation commands that each cause heating of the thermal element for a fixed time slice. In some embodiments, the thermal element once sufficiently heated is configured to create an image in at least a single dot region of a target material when stopped or as it is being moved past the thermal element.

### FIELD OF THE INVENTION

The present subject matter relates to a thermal printer system comprising a thermal print head operatively connected to a print control device. The present subject matter also relates to a method of optimizing heat supplied to the thermal elements of the printhead to ensure a more efficient printing operation.

### BACKGROUND

A thermal printer typically includes a printhead comprising a liner array of thermal elements. Each of the thermal elements produces heat in response to energy supplied by a microcontroller associated with the thermal printer. The microcontroller applies a current or voltage to each of the thermal elements so as to transfer dots onto a media. Each thermal element can transfer a dot, or leave an unprinted area, depending on the amount of energy supplied to the thermal elements.

Typically, more power is supplied to the thermal elements to ensure good print quality. The temperature of thermal elements can be quickly raised by application of energy. However, thermal elements tend to get heated unnecessarily. A longer time is required for the thermal elements to cool because the thermal elements retain heat and/or receive heat radiated from adjacent thermal elements. The increased speed of printing further contributes to retention of heat as the thermal elements are allowed very little time to cool. Due to heat retention, dots are generated even at sites where printing is not desired, thereby affecting print quality. This problem is commonly referred to as hysteresis.

Several approaches have been proposed to overcome the problem of hysteresis. One of the common approaches involves the use of dot history control to regulate the amount of power supplied to each of the thermal elements. Dot history control is typically managed by a microprocessor disposed within the printhead of a printer. However, the flexibility available for power management using microprocessors disposed within the printhead is limited. Finer control over the thermal elements is also difficult to achieve in the existing printheads with history control.

Accordingly, improvements over conventional systems are needed so that finer control can be achieved without any compromise on printing speed and print quality.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The present subject matter provides a thermal printer system that may include a thermal printhead provided with at least one thermal element. In some embodiments, the thermal printhead may be provided with a plurality of thermal elements. Each thermal element produces heat in response to energy that may be supplied by a print control device or by other sources. In some embodiments, the thermal printer system is configured to transmit at least one print control signal or activation command. In some embodiments, the activation command is configured to control heating of the thermal element by heating the thermal element for a unit of time, which may raise the thermal element's temperature sufficient to create a portion of an image such as in a single dot region.

In some embodiments, the activation command causes the thermal element to be heated for a portion of a time that a projection of a thermal element towards a printable area overlaps with the single dot region.

In some embodiments, the activation command comprises one or more pulses. Each pulse may be configured to transmit a series of data corresponding to the thermal element to create a portion of the image.

In some embodiments, each pulse is divided into multiple time slices and a single time slice corresponds to the portion of time to be heated so that a projection of a thermal element towards a printable area overlaps with the single dot region and creates a portion of the image.

In some embodiments, the thermal printer system comprises a print control device that may be operatively coupled to the thermal printhead. The print control device is disposed outside the thermal printhead and is operatively connected to the thermal printhead at one end and connected to a user system at another end.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF DRAWINGS

FIG. 1 illustrates a block diagram of a thermal printer system in accordance with some embodiments.

FIG. 2 illustrates a detailed block diagram of a print control device of the thermal printer system in accordance with some embodiments.

FIG. 3 illustrates exemplary activation commands to be transmitted to corresponding thermal elements, with each activation command being a pulse divided into multiple time slices.

FIG. 4 illustrates an example of creation of a portion of an image using at least one thermal element in accordance with one embodiment the present subject matter.

FIG. 5 illustrates an exemplary illustration of a flowchart for representing the method steps performed by the print control device in accordance with some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the present subject matter can be practiced without these specific details. In other instances, well-known structures and devices are shown in block diagram form in order to facilitate a description thereof.

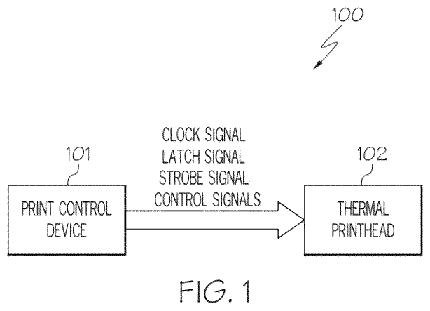

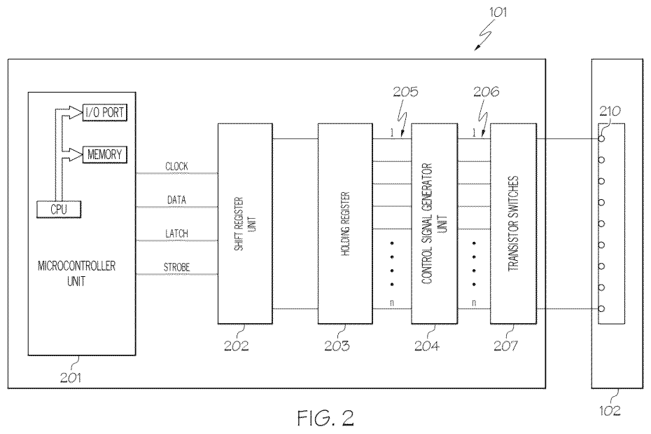

FIG. 1 illustrates a block diagram of a thermal printer system 100 including a thermal printhead 102 according to an embodiment of the present subject matter. FIG. 2 is a block diagram thermal printer system 100 including a print control device 101 according to another embodiment of the present subject matter. The thermal printer system 100 is configured to print/record images on a recording paper such as a thermo-sensitive paper or other kinds of recording medium. The thermal printer system 100 as illustrated in FIG. 1 comprises a print control device 101 operatively connected to a thermal printhead 102. As illustrated, the print control device 101 is disposed outside the thermal printhead 102 and is operatively connected to thermal printhead 102 at one end and to a user system (not shown) at the other end. In some embodiments, the user system is a computer system. In some embodiments, the user system may be a user mobile device. The print control device 101 is configured to receive an image input data that is to be printed/recorded.

Various combinations of one or more of a Clock signal, a Latch signal, a Strobe signal and one or more Control Signals (e.g. activation commands) that may be used for executing a printing/recording action are transmitted from the print control device 101 to the thermal printhead 102, such as through a connector (not shown). The clock signal may enable synchronization when the image input data to be recorded is output to the thermal printhead 102. The latch signal may serve to hold the control signals in a holding register (shown in FIG. 2) before the activation commands are output to the thermal printhead 102. The Strobe signal may serve to validate the image input data transmitted to the thermal printhead 102. Activation commands generated by processing the image input data may be output to the thermal printhead 102 to control power supplied to each thermal element of the thermal printhead 102.

In some embodiments, the thermal printhead 102 includes circuitry enabled to receive, interpret, and/or process the various combinations of the one or more of the Clock signal, the Latch signal, the Strobe signal, and the Control signal. In some embodiments, the control signals provide instructions for creating an image that must be interpreted and converted into direct control over one or more printing elements (e.g., dots) of a thermal printhead 102, such as instructions to place a color at a particular pixel. The thermal printhead 102 may be configured to receive the instruction to place the color at a particular pixel and to then convert that instruction into a pulse-width-modulation (PWM) signal to be sent to the printing element of the thermal printhead 102. That pulse width modulation signal may have a period spanning multiple clock cycles that allow the printing element to be heated up to a portion of the period, such as for the first 5 clock cycles, the first 10 clock cycles, the first 50 clock cycles, etc. In this way, the thermal element may be raised to a threshold temperature to cause thermal ink to be sufficiently heated to be transferred to a substrate such as a thermal paper.

FIG. 2 illustrates a detailed block diagram of the print control device 101 of the thermal printer system in accordance with some embodiments. In an exemplary embodiment, the print control device 101 comprises a microcontroller unit 201 communicatively coupled to a control signal generator unit 204 via a shift register unit 202. In some embodiments, the shift register unit 202 also comprises a holding register 203. The microcontroller unit 201 is configured with memory including a volatile memory and/or a non-volatile memory. The non-volatile memory may include e.g., read-only memory (“ROM”), programmable ROM (“PROM”), erasable programmable ROM (“EPROM”), electrically erasable programmable ROM “EEPROM”), flash memory, etc. coupled with the address/data bus (not shown), wherein the non-volatile memory is configured to store static information and instructions for the control signal generator unit 204. The memory contains data or instructions which when executed by the control signal generator unit 204 generates control signals to be output to each thermal element.

In an exemplary embodiment, the microcontroller unit 201 comprises an input/output port coupled to a memory and a central processing unit. The microcontroller unit 201 receives the image input data inputted from the user system. The image input data in various embodiments comprises serial image input data. The image input data as received by the microcontroller unit 201 is transmitted in the form of serialized input data signals to the shift register unit 202. Besides the image input data, the microcontroller unit 201 may receive all, some, or one of the clock signal, the latch signal and the strobe signal. The shift register unit 202 is configured to output in parallel, print data signals 205 (1 through n) corresponding to the image input data serially inputted, by an amount of one line of the image to be recorded. For example, n number of print data signals can be output in parallel based on the image input data serially inputted.

In an exemplary embodiment, the print data signals 205 (1 through n) are then transmitted to the control signal generator unit 204 via the holding register 203. In some embodiments, the holding register 203 comprising latches serves to hold one line of the print data signal until a second line of image input data is inputted into the shift register unit 202.

In an exemplary embodiment, the print data signals 205 (1 through n) meant for recording a single line of the image input data, and inputted to the control signal generator unit 204, is processed by the control signal generator unit 204 to generate a corresponding set of control signals 206 (1 through n) or activation commands to be output to the thermal printhead 102. Each control signal 206 (1 through n) or activation command is transmitted to each thermal element (210-218). The control signal generator unit 204 may process each print data signal to be output corresponding to each thermal element (210-218).

In an exemplary embodiment, each print data signal is processed by the control signal generator unit 204 to generate a corresponding control signal or activation command that is output as one or more pulses (e.g., one or more quantized activation commands). The control signals thus generated by the control signal generator unit 204 can be transmitted directly to each thermal element of the thermal printhead 102 via transistor switches 207. In some embodiments, the microcontroller unit 201 directly outputs the quantized activation commands, or the microcontroller unit 201 may be combined with other forms of hardware to perform the tasks needed to create the quantized activation commands.

In various embodiments, direct transmission of the control signals in this way may remove the need for additional on-board circuitry on the printhead 102 that is capable of interpreting commands and converting them to additional timing and energizing commands for the thermal printhead 102 thermal element, such as using pulse width modulation.

In various embodiments, a quantized activation command may cause the thermal element of the thermal printhead 102 to be heated for a fixed period of time, such as a single clock pulse. In various embodiments, a quantized activation command may cause the thermal element of the thermal printhead 102 to be heated for a fixed unit of energy, such as the amount of power delivered at a given voltage and current for a fixed period of time.

In some embodiments, heating the thermal element for a greater period of time may be performed by sending a separate quantized activation command for each quantized unit of time needed for activation. In other words, activation for 10 clock pulses for a 1 clock pulse long quantized activation command may be performed by sending 10 quantized activation commands in a row to the same thermal element. In some embodiments, when a quantized activation command is not sent for a given clock pulse, the thermal element of the thermal printhead 102 is not energized for that clock pulse. This system may thus allow for direct control and heating of a given thermal element of a thermal printhead 102 in a fully customizable and/or adaptive way.

Unlike some other methods such as using some pulse-width-modulation systems, a series of heating commands may not be required to be sent at the beginning of a pulse-width-modulation period spanning multiple clock cycles. Also, during given period, instead of being restricted to the first 10%, the first 25%, or the first 50% of a given period, this embodiment using direct control of a thermal element through quantized activation commands may allow the thermal element to be rapidly activated and deactivated for various purposes, such as to control the maximum temperature of the thermal element, or to maintain the temperature of the thermal element at one or more temperatures at different times, or to change the rate of heating or cooling of the thermal element at a much finer scale than typically would be allowed by some pulse width modulation systems. The temperatures targeted for the thermal element may be described by a temperature profile where the thermal element is held at one or more temperatures for one or more time intervals over a given time period. For example, a thermal element may be held at 100 degrees Celsius for 10 seconds, 110 degrees Celsius for 15 seconds, and 90 degrees Celsius for 7 seconds. Other temperatures and time periods may be used as necessary.

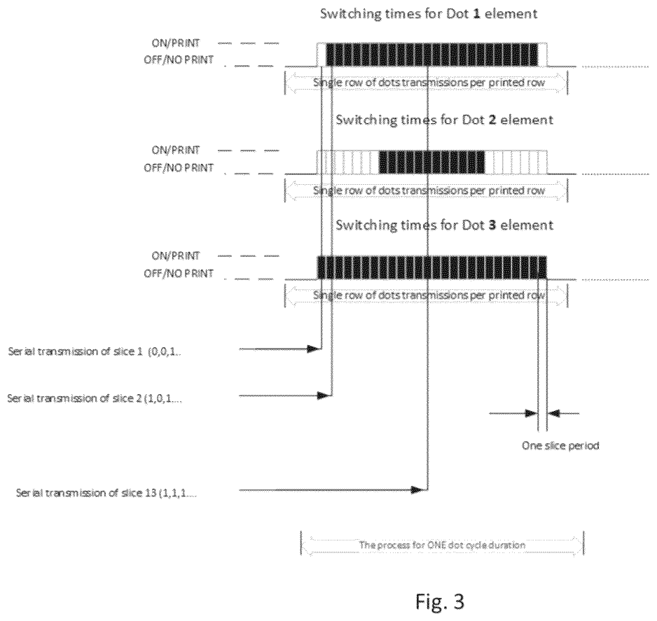

FIG. 3 illustrates exemplary control signals or activation commands to be transmitted to corresponding thermal elements. In some embodiments, each control signal being transmitted as a pulse may be divided into multiple time slices for one or more thermal elements of a printhead 102. The signal generator unit (shown in FIG. 2) may be configured to convert each pulse that is divided into multiple slices into separate quantized activation commands, each corresponding to one time slice (e.g., a predetermined unit of time). In some embodiments, one time slice corresponds to a single clock pulse. In other embodiments, the time slice may correspond to multiple clock pulses or a fixed period of time, such as 1 millisecond, 1 microsecond, 1 nanosecond. Each slice of said multiple slices may have the same duration. In some embodiments, the time duration for each slice is determined by the formula:

$$T ( slice time ) = total number of dots / ( Number of data lines * Clock Speed )$$

This may determine the granularity of ON/OFF time for each slice of a single pulse associated with a single thermal element. The maximum number of ON/OFF slices for a given pulse may be limited by one or more factors, such as duration of a clock pulse, memory limitations, or the number of lines to be printed. In various embodiments, a single bit of the series of data input directly to control a thermal element as a quantized activation command is associated with a single corresponding time slice for one thermal element. The single bit of data may correspond to ON time for a first value or OFF time for the bit's other value. For example, 1 may correspond to energizing a thermal element for one time slice such as at the time the quantized activation command is received by the thermal element, and 0 may correspond to not energizing the thermal element for one time slice such as at the time of receipt of the 0 by the thermal element of the printhead 102. Whether the thermal element prints or does not print at a given target site may depend on whether the thermal element has reached a threshold temperature, above which the ink material it may be placed in contact with may be sufficiently heated to be transferred onto a substrate such as cloth, plastic, or paper (e.g. a target material).

As shown in FIG. 3, a given set of activation commands for a row of thermal elements that may be adjacent to each other may be sent as a command (0, 0, 1) for a first time slice. In that time slice, the thermal elements 1 and 2 may not be heated, while thermal element 3 is energized/heated in that time. In the second identified exemplary time slice, the quantized activation commands may be grouped together as (1, 0, 1), which may energize the first and third thermal elements while not energizing the second thermal elements. In the third identified exemplary time slice, the quantized activation commands may be grouped together as (1, 1, 1), which may energize the first, second, and third thermal elements for the corresponding time slice. For a given time period, the distribution of activation commands for a single thermal element may be regular or irregular. For example, a regular distribution across 100 time slices may include every 2nd, 3rd, 4th, or 5th time slice being activated with non-activated time slices in between. An irregular distribution may include only the prime numbered time slices being activated, or all of the 3rd and 5th time slices being activated, or all of the 13th, 7th, and 23rd time slices being activated, with all other time slices being non-activated. In various embodiments, the activation commands distributed within a given time period may be distributed in one or more of the following ways: evenly, unevenly, clustered in one or more groups, separated by regular or irregular inactivity periods, separated by algorithmically determined or random inactivity periods, or spaced one after another without separation.

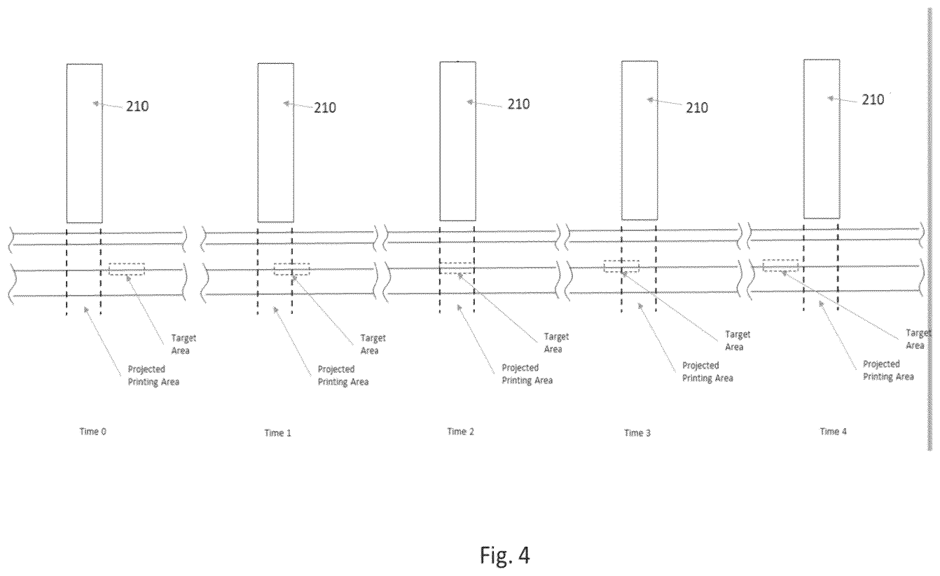

FIG. 4 illustrates an example of creation of a portion of an image/printing of dots using at least one thermal element in accordance with one embodiment the present subject matter. A “single dot region” may be the area covered by a single thermal element, which may correspond to a pixel of resolution for the printhead 102.

FIG. 4 illustrates the various positions of the thermal element 210 at different time intervals as it moves from left to right and the media moves from right to left. Based on the one or more activation commands transmitted corresponding to the target thermal element, say for example, a control signal that is sliced based on the formula described above and transmitted corresponding to the thermal element 210, the thermal element may print or not print at a particular target area. As explained above, if the bit data associated with a given time slice is ON, then heating occurs for the thermal element for the corresponding quantized time slice. Assuming the thermal element has been sufficiently heated through the one or more activation commands it has received within a given time period, then printing occurs on the target print area. If the bit data (e.g., the quantized activation command) associated with the given time slice is OFF then the thermal element is not heated for the corresponding time slice. If the thermal element drops below a threshold temperature, then printing may not occur. In some embodiments, each quantized activation command causes the thermal element to be heated for a portion of the time that the projection of the thermal element towards the target material overlaps with the single dot region on the target material.

In some embodiments, the combined effect of the plurality of activation commands sent to a corresponding thermal element 210 causes it to maintain a temperature that is between a first threshold temperature and a second threshold temperature. In some embodiments, the system is further configured to prevent the thermal element from overheating by maintaining the temperature of the thermal element below the second threshold. In some embodiments, the system is configured to send 1, 2, 3, 5, 10, 20, 30, 50, 100, 200, 500, 1000, 10000, 100000, 1,000,000 or more activation commands within a given time period, such as 1 millisecond, 10 milliseconds, 100 milliseconds, 1 second, or 10 seconds. In some embodiments, the time period is less than a set number of clock pulses and is one of a set time length or a variable time length. In various embodiments, the variable time period is less than 1,000,000,000, 1,000,000, 1000, 500, 100, 50, 10, 9, 8, 7, 6, 5, 4, 3, 2, or 1 clock pulses. In various embodiments,

In various embodiments, the system is configured to extend or shorten the variable time period. In various embodiments, the distribution of activation commands within the time period is irregular. In various embodiments, the system is further configured to refrain from sending an activation command during an inactivity period. In various embodiments, the activation commands are distributed within the time period in one or more of the following ways: evenly, unevenly, clustered in one or more groups, separated by regular or irregular inactivity periods, separated by algorithmically determined or random inactivity periods, or spaced one after another without separation.

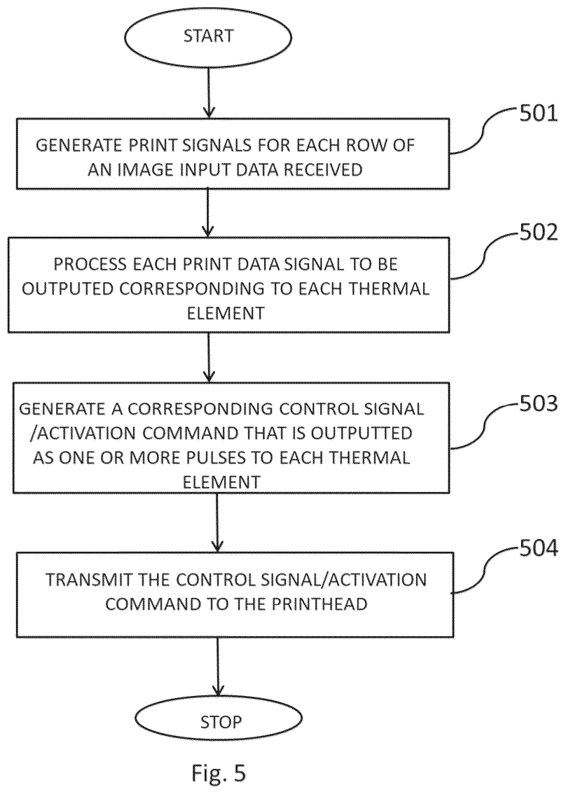

FIG. 5 illustrates a flowchart depicting exemplary method steps performed by the print control device 101 in accordance with some embodiments. The order in which the method may be described is not intended to be construed as a limitation, and any number of method steps may be combined in any order to implement the method. Additionally, individual blocks may be deleted from the method without departing from the spirit and scope of the subject matter described herein. Furthermore, the method may be implemented in any suitable hardware, software, firmware or combinations thereof.

At step 501 the print control device 101 generates print data signals for each row of an image input data received. In an exemplary embodiment, the image input data is output from the shift register (shown in FIG. 2) disposed within the print control device as print data signals in parallel. At step 502, the signal processor unit processes each print data signal to be output corresponding to each thermal element. At step 503, the signal generator generates a corresponding control signal or activation command that is output as one or more pulses to each thermal element. Further, at step 504, the control signals or activation commands generated are transmitted to the thermal printhead via transistor switches to record each row of the image input data.

What has been described above includes examples of the claimed subject matter. It may be, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter may be intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A thermal printer system comprising:
a print control device configured to be operatively connected to a thermal printhead having a thermal element,
wherein the print control device is configured to output a plurality of quantized activation commands that each cause heating of the thermal element for a fixed time slice, wherein the thermal element once sufficiently heated is configured to create an image in at least a single dot region of a target material when stopped or as it is being moved past the thermal element.

2. The system of claim 1, wherein each quantized activation command causes the thermal element to be heated for a portion of the time that the projection of the thermal element towards the target material overlaps with the single dot region on the target material.

3. The system of claim 1, wherein each quantized activation command causes the thermal element to be heated for a predetermined unit of time.

4. The system of claim 1, wherein each quantized activation command causes the thermal element to be heated for a predetermined unit of energy.

5. The system of claim 3, wherein each predetermined unit of time is the same unit of time.

6. The system of claim 3, wherein each predetermined unit of time corresponds to a single clock pulse.

7. The system of claim 3, wherein each predetermined unit of time corresponds to a fixed number of two or more clock pulses.

8. The system of claim 4, wherein each predetermined unit of energy is the same unit of energy.

9. The system of claim 4, wherein each predetermined unit of energy corresponds to energy delivered within a single clock pulse.

10. The system of claim 4, wherein each predetermined unit of energy corresponds to energy delivered within a fixed number of two or more clock pulses.

11. The system of claim 1, wherein the combined effect of the plurality of activation commands causes the thermal element to maintain a temperature that is between a first threshold temperature and a second threshold temperature.

12. The system of claim 1, wherein the system is further configured to prevent the thermal element from overheating by maintaining the temperature of the thermal element below the second threshold.

13. The system of claim 1, wherein the system is further configured to send 1, 2, 3, 5, 10, 20, 30, 50, 100, 200, 500, 1000, 10000, 100000, 1,000,000 or more activation commands within a time period.

14. The system of claim 13 wherein the time period is less than a set number of clock pulses and is one of a set time length and a variable time length.

15. The system of claim 13, wherein the variable time period is less than 1,000,000,000, 1,000,000, 1000, 500, 100, 50, 10, 9, 8, 7, 6, 5, 4, 3, 2, or 1 clock pulses.

16. The system of claim 13, wherein the system is configured to extend or shorten the variable time period.

17. The system of claim 13, wherein the distribution of activation commands within the time period is irregular.

18. The system of claim 1, wherein the system is further configured to refrain from sending an activation command during an inactivity period.

19. The system of claim 13, wherein the activation commands are distributed within the time period in one or more of the following ways: evenly, unevenly, clustered in one or more groups, separated by regular or irregular inactivity periods, separated by algorithmically determined or random inactivity periods, or spaced one after another without separation.

20. The system of claim 1, wherein a single time slice corresponds to a single bit data of the series of data.

21. The system of claim 1, wherein an image is created when the thermal element has reached a threshold temperature by being heated by one or more quantized activation commands.

22. The system of claim 1, wherein said each activation command is transmitted as a part of a set of activation commands that are output in parallel for controlling a single row of thermal elements for a corresponding unit of time.

23. The system of claim 1, wherein the print control device comprises a microcontroller unit having a memory.

24. The system of claim 1, wherein the print control device receives an image input data from a user system.

25. The system of claim 23, wherein the microcontroller transmits the image input data to a shift register disposed within the print control device.

26. The system of claim 24, wherein the image input data comprises a serial image input data.

27. The system of claim 25, wherein the shift register outputs the image input data in parallel.

28. The system of claim 25, wherein the image input data is output from the shift register as print data signals in parallel.

29. The system of claim 28, wherein the print data signals are input to a control signal generator unit disposed within the print control device.

30. The system of claim 29, wherein the print data signals are processed by the control signal generator unit to generate the set of control signals.

31. The system of claim 29, wherein the control signal generator unit outputs the set of control signals to the printhead via a plurality of transistor switches.

32. The system of claim 31, wherein the plurality of transistor switches is disposed within the print control device.

33. The system of claim 25, wherein the shift register is a serial in parallel out (SIPO) shift register.

34. The system of claim 25, further comprising the thermal printhead having the thermal element.

35. A method for controlling an energy profile of each thermal element in a thermal printhead, the method comprising steps of:
generating print data signals in the form of pulses for each row of an image input data received;
determining a time slice for each print data signal; and
transmitting the control signals generated to the plurality of thermal elements of the printhead to record row after row of the image input data.
